(19) United States
(12) Patent Application Publication
(10) Pub. No.: US 2015/0061809 A1
(43) Pub. Date: Mar. 5, 2015

(54) Coil Assembly

(71) Applicant: Phoenix Contact GmbH & Co., KG, Blomberg (DE)

(72) Inventors: Ralf Hoffmann, Berlin (DE); Olaf Abel, Werder (DE); Thomas Kuehne, Berlin (DE)

(21) Appl. No.: 14/388,121

(22) PCT Filed: Mar. 27, 2013
(86) PCT No.: PCT/EP2013/056574

§ 371 Date: Sep. 25, 2014

(30) Foreign Application Priority Data
Mar. 30, 2012 (DE) 10201206434.9

(51) Int. Cl. H01F 5/04; H01H 49/00; H01F 41/06; H01F 5/06

(52) U.S. Cl. CPC H01F 5/04; H01F 5/06; H01H 49/00; H01F 41/0612; H01F 2005/043
USPC 336/192; 29/605

(57) ABSTRACT

A coil assembly is provided, comprising a coil former, a coil, and a connection block which is pivotally joined to the coil former. The coil is wound while the connection block is pivoted away, the winding wire ends are soldered to the terminal pins, and the connection block is pivoted close to the coil.

### FIELD OF THE INVENTION

The invention relates to a method for producing a coil assembly and to such a coil assembly, in particular for use in a relay, the coil assembly comprising an insulating coil former as a winding support, with a coil wound around the winding support, and a connection block on the flange of the coil for connecting the winding wire ends to terminal pins.

### BACKGROUND OF THE INVENTION

EP 2 187 418 A2 discloses a relay including a relay core member having a magnetic core, a yoke, a coil, and an insulating coil former in form of two frames, the second frame defining a coil flange with a connection block which projects beyond the coil axis and in which two terminal pins for the winding wire ends are secured. With this configuration of the relay core member, an installation length is resulting, which is greater than the actual length of the coil former when considering the length of the coil axis from coil flange to coil flange.

From DE 84 28 722 U1 a coil former is known, that has an excitation winding between peripheral end flanges, and a plastic bracket with a hinge-type joint integrally molded to one end flange can be latched at the other end flange after having been folded. With this configuration, the coil must not have a large length. The plastic bracket has fitting openings with terminal pins inserted therein, that can be soldered to the winding ends of the coil. Once the bracket has been folded, the terminal pins with their ends project beyond the periphery of the coil, without however compromising the length of the coil.

U.S. Pat. No. 4,912,438, U.S. Pat. No. 5,153 543, and U.S. Pat. No. 6,670,871 B1 disclose polarized relays comprising a coil assembly, with a rocking armature, and a base housing. The coil assembly comprises a magnetic core, a coil former, a wound coil, and a permanent magnet. The base housing is a plastic box which opens to the upper side, and which has stationary contact terminals and coil terminals on its end faces, and terminal pin on its lateral sides. The rocking armature is mounted on the permanent magnet above the coil assembly and the base housing and supports the movable contact terminals of the relay switches. Because of the lateral arrangement of the terminal pins, a narrow configuration of the relay is not possible.

### SUMMARY OF THE INVENTION

The invention is based on the object to provide a coil assembly with coil, insulating coil former, and connection block, which has length as measured in the direction of the coil axis, that does not significantly exceed the length of the coil, that means which is shorter than the relay core member of EP 2 187 418 A2. The coil may have a large length. Further it is intended to exploit the space at the coil assembly to an optimum. In particular, the coil assembly shall be suitable for a relay, whose terminal pins extend from the radially outer region of the coil.

According to the invention, a method is proposed for producing a coil assembly which is suitable for being installed in a relay, and which comprises an insulating coil former as a winding support, a coil, and terminal pins for electrical connection to the coil. The insulating coil former which defines a coil axis is provided with a coil connection flange to which a connection block is pivotally attached. The connection block which accommodates the terminal pins partially embedded in an insulating block body is arranged in preparatory position in which it extends within the space outside the outer space of the coil required for winding. Then, a winding wire is wound around the coil former, and the winding wire ends are led out from the coil near the coil connection flange and connected to the associated terminal pins. Thereafter, the terminal pins are bent. As a next step, the connection block is bent with respect to the coil former about a deformation portion. This moreover leads to a strain relief for the winding wire. In this manner, a coil assembly can be obtained, in which the terminal pins virtually extend from within the coil winding space, and do not extent from a space in extension of the coil axis nor do they extend in planes laterally from the coil. So a coil assembly of a very short configuration when compared to the length of the coil is achieved. The coil assembly may be handled separately from a pole assembly in which an unmagnetized ferromagnetic body is to be magnetized to obtain a polarized relay.

The coil assembly according to the invention may be implemented in different variations. Many configurations use an extension fixed to the coil connection flange and having a flexible deformable joining area to the connection block which is pivoted from its preparatory position to its final position.

In a first embodiment, the extension is integrally connected to the connection block through a flexible deformable hinge portion.

In other embodiments, a metallic bending zone is provided on a metallic member which may be one of the terminal pins or a separate bending arm. It is also possible to obtain a connection of the connection block to the extension secured to the coil connection flange via a torsion element.

Exemplary embodiments of the invention will now be described with reference to the drawings.

### BRIEF DESCRIPTION OF THE DRAWINGS

In the drawings:

FIG. 1 shows a coil former with a coil connection flange and an integrally connected connection block, in a preparatory position;

FIG. 2 shows the coil assembly with the connection block in the final position;

FIG. 3 shows a coil former with a coil connection flange and a connection block connected through a terminal pin, in the preparatory position;

FIG. 4 shows the coil assembly with the connection block of FIG. 3 in the final position;

FIG. 5 shows a coil former with a coil connection flange and a connection block connected through a bending arm, in the preparatory position;

FIG. 6 shows the coil assembly of FIG. 5 with the connection block bent close to the coil;

FIG. 7 shows a coil former with coil connection flange, which is connected with the connection block via a torsional joint; and

FIG. 8 shows the coil assembly of FIG. 7 with the connection block in the final position.

### DETAILED DESCRIPTION

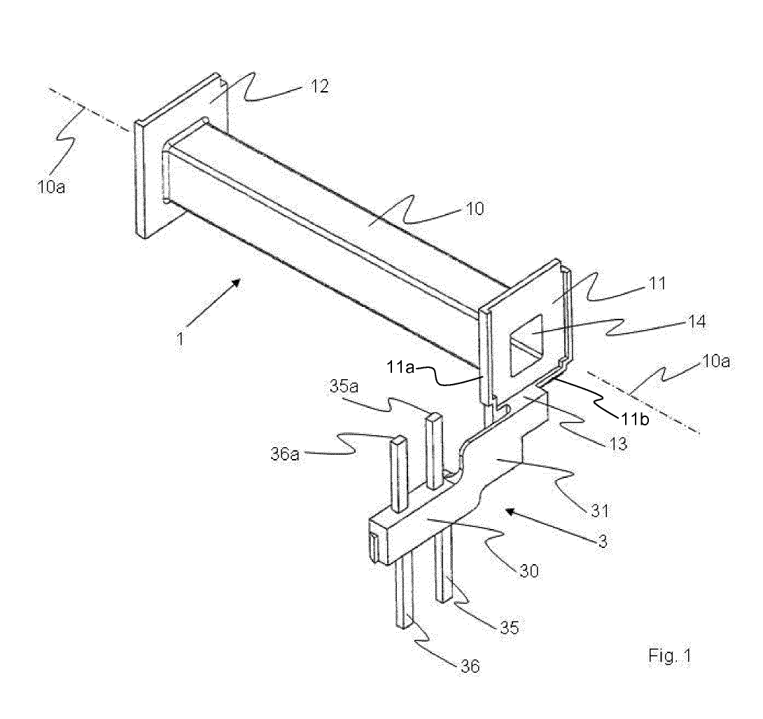

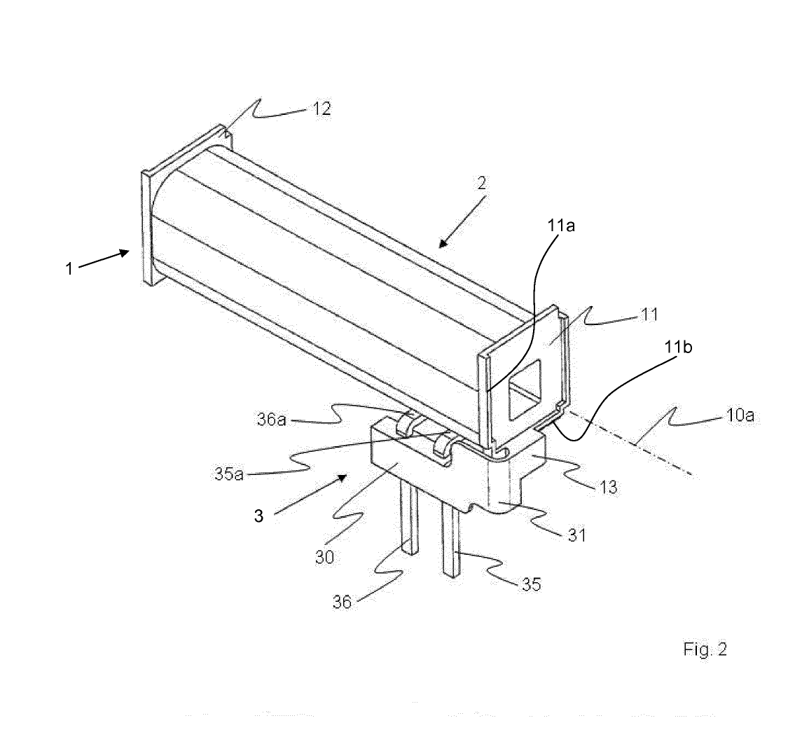

FIGS. 1 and 2 show a first embodiment of a coil assembly according to the invention. The main parts of the coil assembly are an insulating coil former 1, a coil 2, and a connection block 3 which can be pivoted from a preparatory position as seen in FIG. 1 to a final position as seen in FIG. 2. The coil former 1 has a coil tube 10 with a longitudinal cavity 14 which define a coil axis 10a, and two flanges 11 and 12 at the ends of coil tube 10. Flange 11 has peripheral edges, and the pivoting of connection block 3 is effected in extension of peripheral edge 11a. An extension 13 is secured to peripheral edge 11b of flange 11 and is integrally joined to connection block 3. Connection block 3 comprises an insulating block body 30 and a flexible deformable hinge portion 31 on the extension of peripheral edge 11a. Coil former 1 with flange extension 13, hinge portion 31, and block body 30 are made of electrically insulating material which is suitable for overmolding metallic parts. Such metallic parts are the terminal pins 35, 36 which are partially embedded in body block 30 and protrude from block body 30 with their ends 35a, 36a.

FIG. 1 shows the coil former 1 with connection block 3 in the preparatory position before the winding is placed around coil former. As can be seen, coil tube 10 between flanges 11 and 12 is accessible without hindrance from the lateral side, which means that the connection block 3 is located outside the contour of coil connection flange 11 and outside the required space for winding the coil winding. In this position of the connection block 3 the coil former 1 receives the winding thereby forming the coil 2 (FIG. 2) which has two winding wire ends, not shown, which are led out from the coil in the region of flange 11 and which are connected to terminal pins 35 and 36, for example by soldering. Subsequently, the upwardly projecting ends 35a and 36a of terminal pins 35, 36 are bent over into a plane in parallel to the coil axis 10a. Then, the hinge portion 31 of connection block 3, which together with its terminal pins 35 and 36 is located in a main plane transversely to the coil axis 10a (FIG. 1) is bent about an axis approximately in the extension of peripheral edge 11a, so that the block body 30 substantially extends in parallel to the coil axis 10a, as illustrated in FIG. 2.

The novel coil assembly is distinguished by a short installation length. In the installation space, the terminal pins 35, 36 will be arranged immediately beneath the coil 2, i.e. the width of flanges 11, 12 covers the terminal pins 35, 36. Therefore, the coil assembly is ideally suited for being installed into small or narrow relays, and also into relays having a long coil former 1.

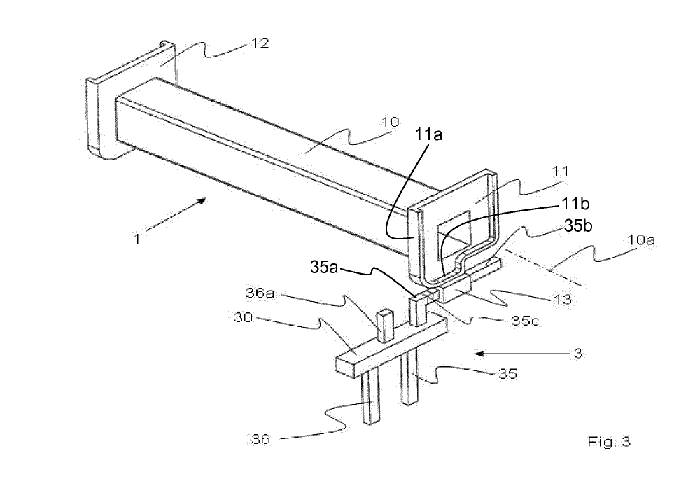

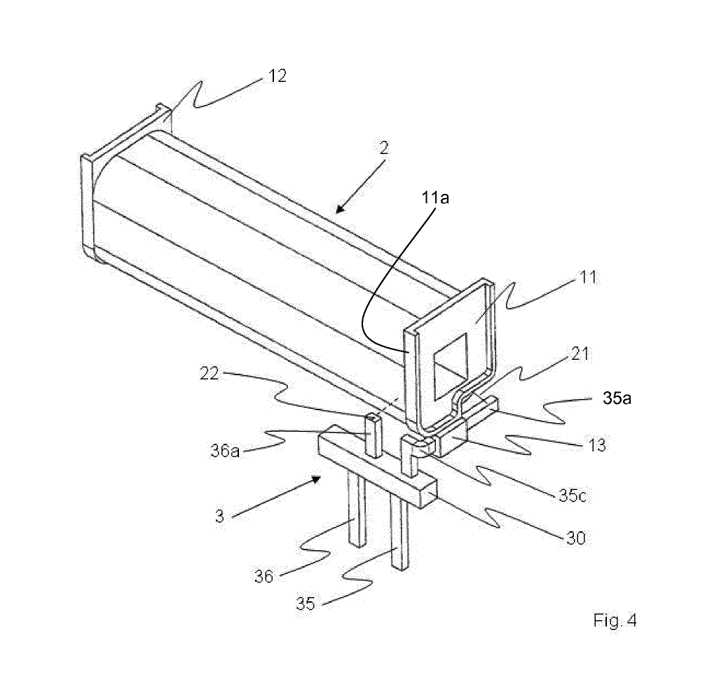

FIGS. 3 and 4 illustrate a further embodiment of the novel coil assembly. Similar parts are designated with the same reference numerals as in the embodiment of FIGS. 1 and 2. The principal difference is the connection between flange extension 13 and block body 30. In fact, a cranked terminal pin 35 is used for this purpose, which is deflected at its the upper end 35a and has an angled section 35b which is anchored in flange extension 13. Additionally, terminal pin 35 has a bending zone 35c between sections 35a and 35b, which is located approximately on the extension of peripheral edge 11a. Terminal pin 36 is also cranked, as seen from the projecting end 36a. Coil 2 is wound around coil former 1 in the manner described before, while connection block 30 is arranged in its preparatory position as seen in FIG. 3. Then, the winding wire ends 21 and 22 are soldered or otherwise connected to terminal pin ends 35a and 36a. Afterwards, terminal pin 35 is bent about its bending zone 35c so that connection block 3 assumes the final position illustrated in FIG. 4 in which the main plane of the connector block 30 is in parallel to coil axis 10a.

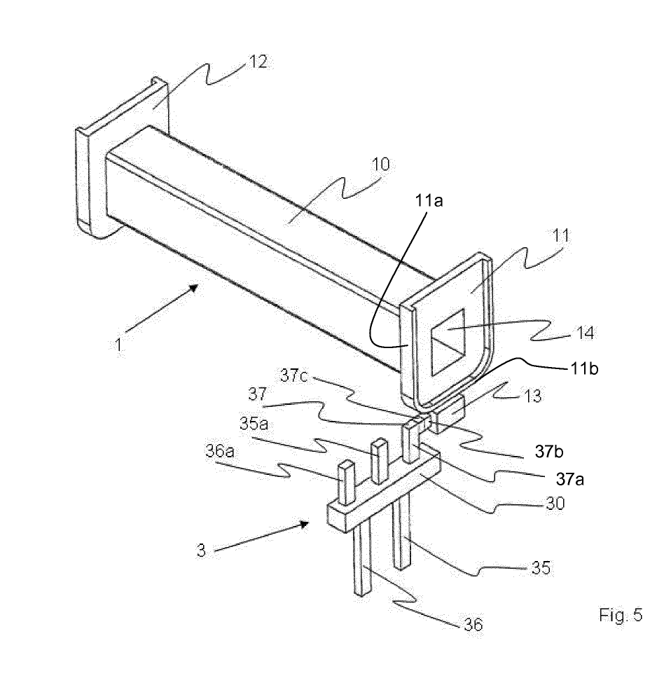

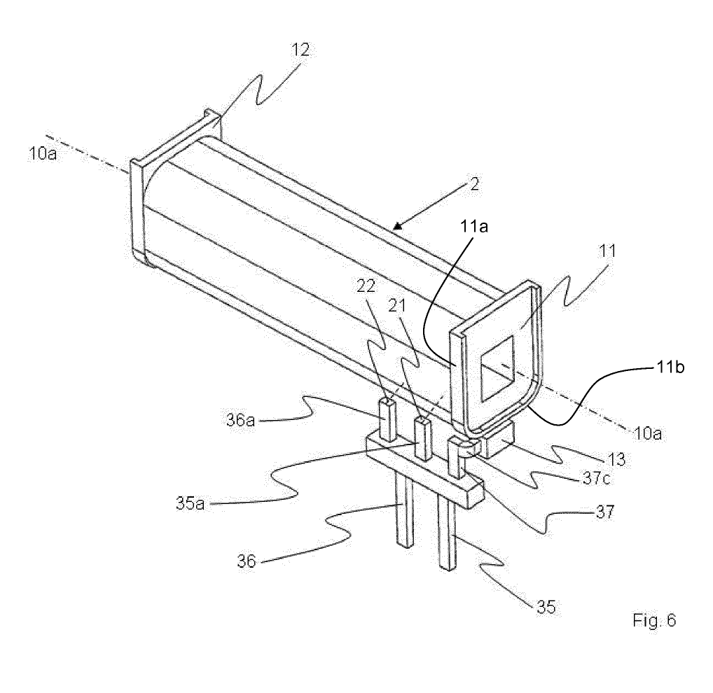

FIGS. 5 and 6 show a third embodiment of the invention. Equivalent parts are designated with the same reference numerals. The characteristic feature of the third embodiment is a bending arm 37 which has a first leg 37a anchored in block body 30, while the second leg 37b is anchored in flange extension 13. Bending arm 37 may be an angled part similar to sections 35a, 35b, and 35c of terminal pin 35, which may additionally have a cranked fork end 35a. The winding is applied around coil former 1, and wire ends 21, 22 are electrically conductively connected to the free ends 35a and 36a of terminal pins 35, 36. As described above, connection block 3 is pivoted from its preparatory position illustrated in FIG. 5 to the final position shown in FIG. 6, whereby the bending zone 37c of bending arm 37 is permanently deformed.

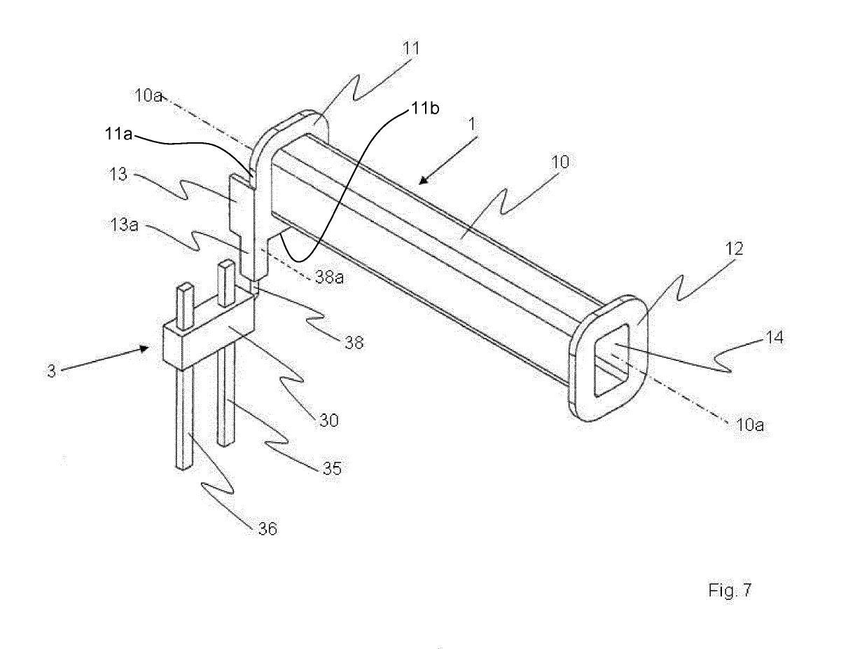

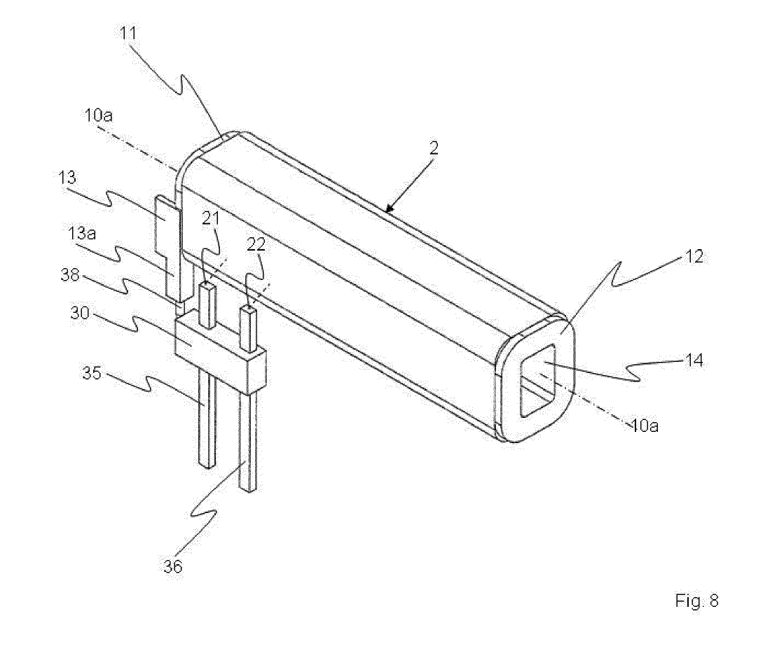

FIGS. 7 and 8 show a fourth embodiment of the invention.

The same reference numerals as before are used. Extension 13 on coil connection flange 11 has a downwardly extending projection 13a for accommodating a torsion leg 38a of an elbow-shaped joining member 38. The angled leg of joining member 38 extends into and is anchored in block body 30. In the preparatory position as seen in FIG. 7, the main plane of connection block 3 extends transversely to the coil axis 10a, and in this preparatory position the coil 2 is wound, whereupon the winding wire ends 21, 22 are soldered or otherwise conductively connected to their respective terminal pins 35, 36. Thereafter, connection block 3 is pivoted from the position of FIG. 7 into the position of FIG. 8, whereby the torsion leg 38a of the elbow-shaped joining member 38 is twisted and undergoes permanent deformation.

It will be apparent to those skilled in the art that the embodiments described above are intended as examples and that the invention is not limited thereto but may be varied in many ways without departing from the scope of the claims. Furthermore, the features also define individually significant components of the invention, irrespective of whether they are disclosed in the description, the claims, the figures, or otherwise, even if they are described together with other features.

What is claimed is:

1. A method for producing a coil assembly suitable for being installed in a relay and comprising an insulating coil former as a winding support, a coil, and terminal pins for electrical connection to the coil, comprising the steps of:
a) providing the insulating coil former which defines a coil axis and has a coil connection flange with a first peripheral edge and a second peripheral edge perpendicular thereto, and an extension extending from the second peripheral edge, with a connection block pivotally joined thereto which, in a preparatory position, extends outside the outline of the coil connection flange and outside the coil winding space required for winding, and which connection block accommodates the terminal pins partially embedded in an insulating block body;
b) winding a winding wire around the coil former to produce the coil, and leading out the winding wire ends close to the coil end at the coil connection flange;
c) connecting the terminal pins to associated winding wire ends; and
d) pivoting the connection block about an axis extending approximately in extension of the first peripheral edge of the coil connection flange into a final position overlapping the coil winding space, while a deformation section is bent.

2. A coil assembly, comprising:
an insulating coil former as a winding support, which defines a coil axis and has a coil connection flange mounted on an axial end of the insulating coil former, the coil connection flange having a first peripheral edge and a second peripheral edge perpendicular thereto, and an extension attached to the second peripheral edge;
a coil wound around the coil former and having winding wire ends which are connected to at least a first and a second terminal pin when the coil assembly is completed; and
a connection block which is joined to the extension and is pivotable around an axis that extends approximately in extension of the first peripheral edge by being bent and thereby being deformed, and which accommodates the terminal pins partially embedded in an insulating block body;
wherein the joint between the connection block and the extension is a joining area that is deformable by being bent so that prior to applying the winding around the coil former the connection block can be placed in a preparatory position outside the coil winding space required for winding, and can be pivoted into a final position overlapping the coil winding space when the winding has been completed.

3. The coil assembly as claimed in claim 2, wherein the extension fixed to the coil connection flange is joined to the connection block through a flexible deformable hinge portion which enables to position the connection block with the terminal pins partially embedded therein in the preparatory position and in the final position.

4. The coil assembly as claimed in claim 3, wherein, in the preparatory position, the terminal pins are in a plane transversely to the coil axis, and wherein, in the final position the ends of the terminal pins proximal to the coil are bent into a plane in parallel to the coil axis.

5. The coil assembly as claimed in claim 2, wherein a deflected leg of the first terminal pin extends through the extension, and wherein the other leg thereof as well as the second terminal pin extend through the insulating block body of the connection block; and
wherein the deflected leg of the first terminal pin has a bending zone for bending the first terminal pin to bring the connection block from its preparatory position transversely to the coil axis to its final position in parallel to the coil axis.

6. The coil assembly as claimed in claim 2, wherein a deflected leg of a bending arm is anchored in the extension and the other leg thereof as well as the terminal pins are anchored in the insulating block body of the connection block, and wherein the deflected leg of the bending arm has a bending zone for bending the bending arm to bring the connection block from its preparatory position transversely to the coil axis to its final position in parallel to the coil axis.

7. The coil assembly as claimed in claim 2, wherein a torsion leg of an elbow-shaped joining member is anchored in the extension, while the other leg of the joining member is anchored in the insulating block body of the connection block; and
wherein the connection block with its terminal pins can be brought from its preparatory position transversely to the coil axis to its final position in parallel to the coil axis by twisting the torsion leg.
